(19) United States
(12) Patent Application Publication
(10) Pub. No.: US 2002/0004699 A1
(43) Pub. Date: Jan. 10, 2002

(54) System and method for guiding a vehicle

(76) Inventors: Christer Fahraeus, Lund (SE); Erik Persson, Lund (SE)

Correspondence Address: BIRCH STEWART KOLASCH & BIRCH, PO BOX 747, FALLS CHURCH, VA, 22040-0747, US

(21) Appl. No.: 09/812,893

(22) Filed: Mar. 21, 2001

Related U.S. Application Data
(60) Provisional application No. 60/207,840, filed on May 30, 2000.

(30) Foreign Application Priority Data
Mar. 21, 2000 (SE) 0000948-0

(51) Int. Cl. G01C 21/00

(52) U.S. Cl. 701/200; 701/217

(57) ABSTRACT

Systems and methods consistent with the present invention may include a surface for guiding a vehicle in an operating area. The surface may include a position-coding pattern having an arbitrary subset of a predetermined size. The subset may identify a unique position in the operating area. The vehicle may then determine its absolute position within the operating area by recording an image of the arbitrary subset on the surface. In addition, systems and methods consistent with the present invention may also include a self-guided vehicle for operation on a surface. A control means may control the movement of the vehicle. An image sensor may record an image of the surface having a position-coding pattern. The control means may then convert the recorded position-coding pattern into a position of the vehicle and then control the movement of the vehicle in response to the vehicle position.

### CROSS-REFERENCE TO RELATED APPLICATIONS

This application claims priority benefits based on Swedish Patent Application No. 0000948-0, filed on Mar. 21, 2000, and U.S. Provisional Application 60/207,840, filed on May 30, 2000, the technical disclosures of both of which are hereby incorporated herein by reference.

### BACKGROUND OF THE INVENTION

1. Field of the Invention

The present invention relates to self-propelled vehicles and to systems and methods for guiding a self-propelled vehicle.

2. Description of the Related Art

Self-propelled vehicles are becoming ever more common in industry. Such vehicles include various types of robots used in a number of applications. For example, robots are used to move items stored in storage warehouses or to move cars between different assembly stations.

Automated self-propelled vehicles either move by themselves in a predetermined pattern, or they include a guidance system to navigate a certain area.

U.S. Pat. No. 4,656,406 discloses a system for guiding automated vehicles that sense an electric field from wires buried underneath the floor. As a result, the vehicle can follow the guidepath provided by the wires. A drawback of this system, however, is that it may require a considerable investment to change the path followed by the vehicle.

U.S. Pat. No. 5,814,961 discloses an optical guidance system for an automated vehicle. The '961 patent discloses that the floor on which the vehicle moves has grooves defining the path of the vehicle. The vehicle then optically detects these grooves as it moves. However, this system may also require a substantial investment if one desires to change the path of the vehicle since the grooves in the floor must be changed.

U.S. Pat. No. 5,999,866 describes a vehicle that records images on the floor on which it moves and compares the recorded images with a stored image of the floor. Based on this comparison, the vehicle can then determine its position. Thus, in this system, the entire floor surface may need to be mapped before the vehicle can navigate on its own. Moreover, the appearance of the floor may change over time due to wear, thus requiring remapping of the surface at periodic intervals.

### SUMMARY OF THE INVENTION

Systems and methods consistent with the present invention allow a user to easily and efficiently guide a vehicle using a position-coding pattern.

More specifically, systems and methods consistent with the present invention may include a surface for guiding a vehicle in an operating area. The surface may include a position-coding pattern having an arbitrary subset of a predetermined size. The subset may identify a unique position in the operating area. The vehicle may then determine its absolute position within the operating area by recording an image of the arbitrary subset on the surface.

Systems and methods consistent with the present invention may also include a self-guided vehicle for operation on a surface. A control means may control the movement of the vehicle. An image sensor may record an image of the surface having a position-coding pattern. The control means may then convert the recorded position-coding pattern into a position of the vehicle and then control the movement of the vehicle in response to the vehicle position.

The foregoing summarizes only a few aspects of the invention and is not intended to be reflective of the full scope of the invention as claimed. Additional features and advantages of the invention are set forth in the following description, and may be apparent from the description, or may be learned by practicing the invention. Moreover, both the foregoing general description and the following detailed description are exemplary and explanatory and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a schematic view of a surface consistent with the present invention used for guiding a vehicle;

FIG. 2 is a diagram of coding symbols used in a position-coding pattern consistent with the present invention;

FIG. 3 illustrates a coding sequence used to code the position-coding pattern according to a preferred embodiment of the present invention;

FIG. 4 is a cross-sectional view of a vehicle consistent with the present invention;

FIG. 5 illustrates in more detail view of the surface of FIG. 1;

FIG. 6 illustrates a method consistent with the present invention for converting the position-coding pattern to a position value; and

FIG. 7 illustrates the conversion of part of the separating coding pattern to a value.

### DETAILED DESCRIPTION OF PREFERRED EMBODIMENTS

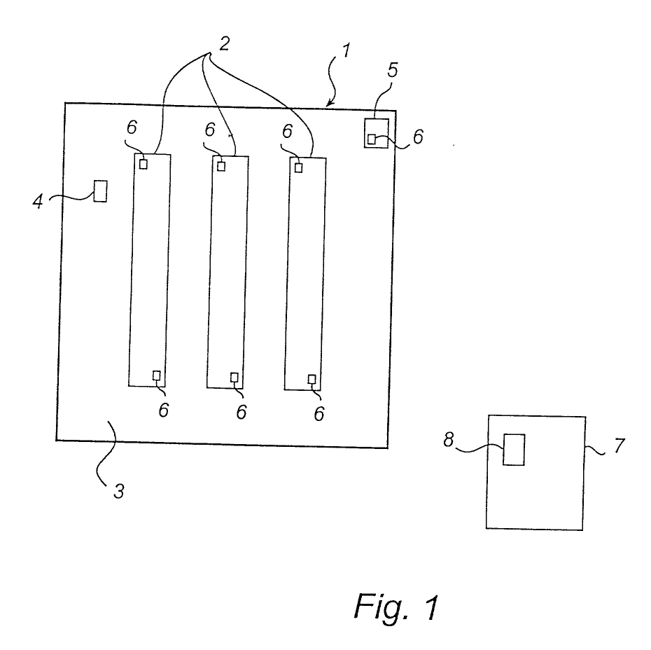

Systems and methods consistent with the present invention will now be described in detail with reference to the accompanying drawings. FIG. 1 is a schematic view of a storage area 1 having a plurality of shelves 2 and pallets 5 located on a floor 3. The floor 3 may further include a position-coding pattern (not shown in FIG. 1) used by an automated self-propelled vehicle 4 to navigate the storage premises 1. For example, the position-coding pattern may be a plastic film overlaid on the floor of the area 1, thus not requiring a specially constructed floor. Both the shelves 2 and the pallets 5 may include position devices 6 that record the position-coding pattern on the floor 3.

For example, FIG. 1 shows that the shelves 2 may each be provided with two of the position devices 6 for establishing the area that the shelves occupy on the floor 3. The position devices 6 may then communicate with a central control device 7 having a memory 8 that may store information about any obstacle occupying a portion of the floor 3. Accordingly, vehicle 4 can receive from control device 7 updated information about obstacles (e.g., shelves 2 or pallets 5) located on floor 3. Alternatively, the system may not use position devices 6 and, in which case, the vehicle 4 may be manually updated with new positions of shelves 2 or the pallets 5.

In a preferred embodiment, items may be placed on top of the pallets 5 and moved throughout the storage area 1. When a pallet is moved to a new position, a position device associated with that pallet may detect that it has been moved to a new position and transmits the new position information to the central control device 7. In turn, the central control device 7 may transmit the position information to vehicle 4 in the storage area 1.

The position-coding pattern may comprise a coding pattern that encodes each position within the pattern by a particular symbol, as described in U.S. Pat. No. 5,852,434, the technical disclosure of which is incorporated herein by reference. Alternatively, the position-coding pattern may use multiple symbols to respectively encode multiple positions, as disclosed in WO 00/73983, PCT/SE00/01895, and WO 01/16691, corresponding to Swedish Patent Application Nos. 9901954-9, 9903541-2, and 9903051-2, respectively, the technical disclosures of which are incorporated herein by reference. For example, WO 00/73983 discloses a position coding pattern having a large dot representing a “one” and a small dot representing a “zero”. Thus, differently sized dots may represent different values. Further, the PCT/SE00/1895 and WO 01/16691 applications disclose that the coding pattern may encode four possible values by having four different displacements of a dot in relation to a raster point.

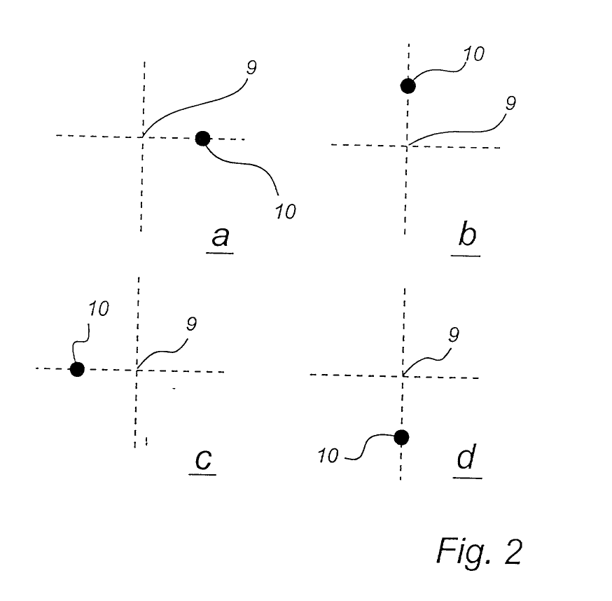

FIGS. 2a-d show exemplary symbols consistent with the present invention for coding positions in the position-coding pattern located on floor 3. As shown in FIG. 2, each symbol may be defined by a mark 10 and a virtual raster point 9, corresponding to the intersection between two raster lines. The value of each symbol may be based on the location of mark 10 in relation to raster point 9. For example, FIG. 2 illustrates four possible locations of mark 10. In each case, the mark 10 is located on a raster line a predetermined distance away from point 9. In this way, the symbol can define four different values. In particular, the symbol of FIG. 2a has the value “0”, the symbol of FIG. 2b has the value “1”, the symbol of FIG. 2c has the value “2”, and the symbol of FIG. 2d has the value “3”. Thus, each symbol can thus represent one of four different values (e.g., “0-3”).

The distance between two adjacent raster points may preferably be about 3 to 12 mm, with the displacement of the mark 10 from the raster point 9 being about ¼ to ⅛, (preferably ⅙) of the total distance between adjacent raster points. In this exemplary embodiment, the effective diameter of the mark 10 is also preferably about 5% to 240% of the total displacement of the mark from the raster point. However, the invention in its broadest sense is not limited to particular dimensions.

FIG. 3 illustrates a sequence 11 consistent with the present invention and which may be used in the position-coding pattern on the floor 6. The sequence 11 may include a string of digit values 12, each of which, in this case, is either a “0” or a “1”. Each arbitrary subsequence (e.g., 13 or 14) of five values unambiguously defines a unique value corresponding to the position of that subsequence in the overall sequence 11. Each subsequence may occur in the sequence only once. Thus, the first subsequence 13 corresponds to the value “0” and the second subsequence 14 to the value “1”.

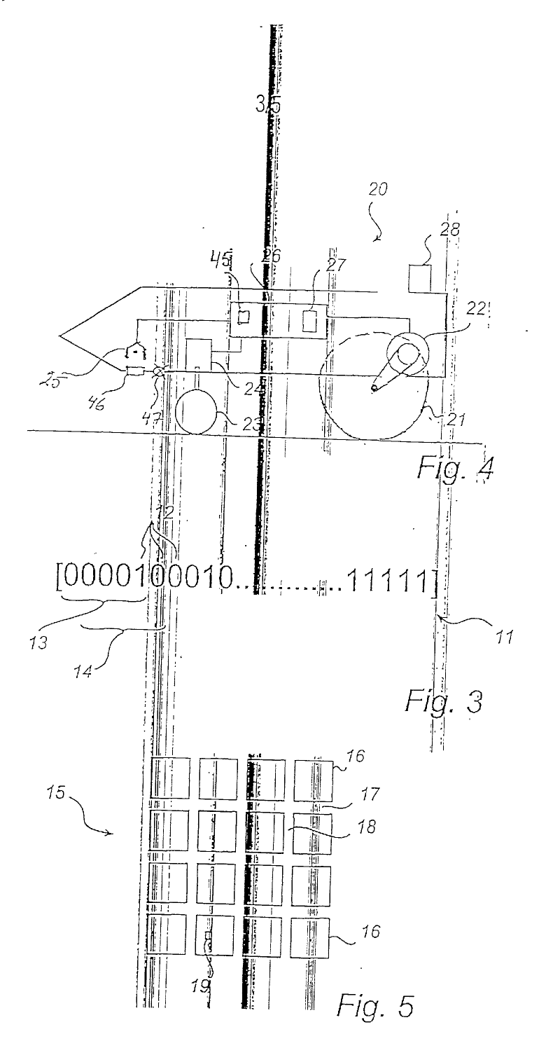

FIG. 4 is a cross-sectional view of a vehicle 20 consistent with the present invention. The vehicle 20 may include a drive wheel 21 driven by a motor 22, a steering wheel 23 controlled by a control motor 24, an image sensor 25 for recording an image of the floor, and a control means 26 coupled to a memory 27. The image sensor 25, which may be, for example, a video camera, optical imager, or electromagnetic radiation imager, further may include a lens 46 and a lamp 47 (e.g., emitting infrared or visible wavelength light) for illuminating the portion of the floor to be recorded. The control means 26 may further include a programmable computer having a timer 45, such as an oscillator, for measuring time.

As shown in FIG. 4, the vehicle 20 may include a transceiver 28 for communicating with the central control device 7. The control means 26 may calculate a position on the basis of an image of a position-coding pattern recorded by the image sensor 25. The control means 26 may then control the drive motor 22 and the control motor 24 based on the calculated position of vehicle 20 within the storage area 1.

In this respect, the memory 27 preferably contains information about where the shelves 2, pallets 5, or other obstacles are located within the storage area 1, as well as information about the walls or boundaries of the storage area 1. The memory 27 may also store instructions for defining the movement of the vehicle 20 within area 1, and for storing instructions for when the vehicle 20 encounters a moving obstacle. These instructions are preferably entered into memory 27 using a computer and define the movement pattern of the vehicle 20 with respect to the location of the shelves 5 in the storage area 1. The vehicle runs along the programmed path by comparing its calculated position with the programmed path in the memory 27. In this way, the vehicle 20 does not need to communicate with an external computer when moving. However, the central control device 7 may also transmit update information to the vehicle 20 on the position of obstacles.

The timer 45 of the control means 26 may be used to calculate a speed and a direction of the vehicle. For example, the control means 26 may measure two position points based on the last two recorded images. The timer 45 may then measure the time elapsed between the recording of these two images. From these two position values and the time it took the vehicle 20 to travel between these two positions, the control means 26 may calculate the vehicle's current speed and direction. The speed and direction may then be used when controlling the movement of the vehicle 20.

Thus, in systems consistent with the present invention, the control means 26 may convert the image of the position-coding pattern into a position. In this case, the vehicle 20 may not communicate the image to an external computer. However, the vehicle 20 may alternatively record the image and transfer it to an external computer that converts the image into a position. In this way, the computational burdens imposed on the vehicle 20 are reduced.

The movement of vehicle 20 may also be programmed or controlled by using a drawing or “blueprint” (in paper or electronic form) of storage area 1 which has a position-coding pattern similar to that on the floor 3 of area 1. A user may then select the movement of the vehicle by scanning a device (e.g., a pen having an image sensor) over the blueprint to record portions of the pattern and to determine the corresponding coordinate positions. The determined coordinate positions of the blueprint, which correspond to the actual coordinate positions in storage area 1, are then stored in a blueprint coordinate sequence corresponding to the desired path of the vehicle. This sequence may then be transferred from the scanning device to a computer which controls the movement pattern of vehicle 20. In this way, a user may easily define the vehicle's movement pattern by simply tracing a path over a blueprint of the storage area. However, graphics tablets or dedicated computers maybe used to define the vehicle's movement path.

FIG. 5 illustrates in more detail part of the floor in the storage area of FIG. 1. As shown in FIG. 5, the floor 15 may include a plurality of floor plates 16 each having a position-coding pattern. Each floor plate 16 may preferably code positions in a virtual area common to all floor plates. In other words, each floor plate may contain the same position-coding pattern defining the same positions. When the vehicle 20 is on a floor plate, it can determine its position within that plate by recording an image of the floor and calculating the position that corresponds to the recorded pattern. Further, the memory 27 preferably contains information about the particular plate 16 on which the vehicle is located. This may be done by having a plate coordinate unique for each plate 16.

Between the plates 16, there may be separating fields 17, 18, which may consist of plastic strips attached to the floor and containing a position-coding pattern. The position-coding patterns of the separating fields preferably use different symbols than those used in the coding pattern on plates 16. In this way, the vehicle can detect when it transitions from a plate to a separating field. When the vehicle 20 passes over a separating field, the control means 26 may update the plate coordinate by recording an image of the separating field converting it to the plate coordinate. The position-coding patterns of all of the plates 16 are preferably aligned in the same direction. Consequently, the vehicle 20 can determine between which plates it moves. If the vehicle reverses its direction, the vehicle will detect that it returns to the same floor plate since it will return to the same part of that plate, instead of coming to the opposite part of an adjacent floor plate.

According to an alternative embodiment of the present invention, each floor plate may code unique absolute positions. Thus, an automated self-propelled vehicle can determine its absolute position in the storage area by recording an image of the floor and converting the position-coding pattern to a unique position within area 1.

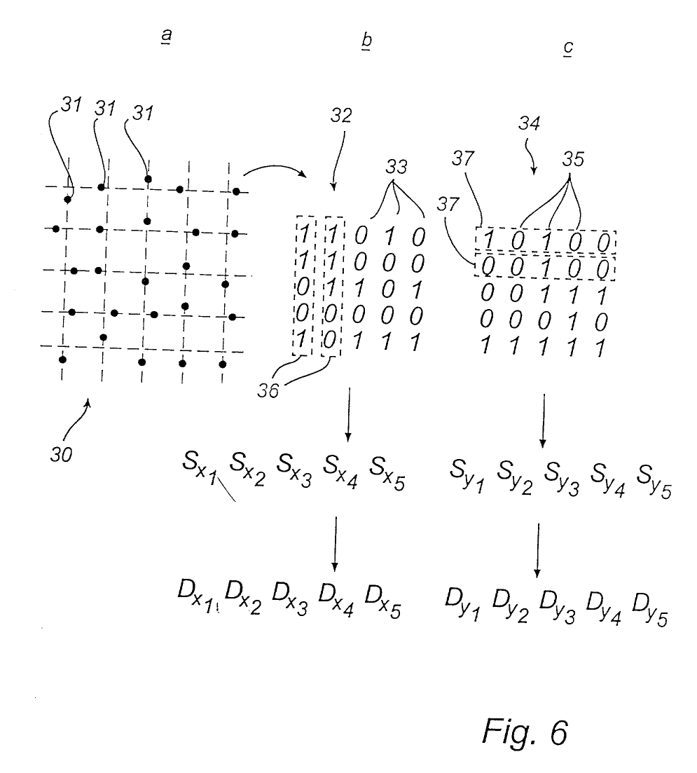

FIG. 6 illustrates an exemplary portion of the position-coding pattern placed on the floor 3 of FIG. 1 and on each of the plates 16 of FIG. 5. A first matrix 30 in FIG. 6a is a portion of matrix that unambiguously defines a position. In FIG. 6, the position-coding pattern comprises symbols 31 like those shown in FIG. 2. The position-coding pattern may use the four different values to code a binary bit in each of two orthogonal directions. Thus, the four different values “0, 1, 2, 3” code the four different bit combinations (0, 0), (0, 1), (1, 0), (1, 1), where the first digit in each bit combination relates to a first direction and the second digit relates to a second direction orthogonal to the first direction.

When the vehicle records the image of the first matrix 30 of FIG. 6, it is preferably converted into a second matrix 32 with values 33 defining the x coordinates, and into a third matrix 34 with values 35 defining the y coordinates. As described above, the first matrix 30 is converted into the second and third matrices 32 and 34 based on the predefined relationship between the values and the bit combinations. As shown in FIG. 6b, the second matrix 32 contains a column corresponding to the subsequences 36. The values in the matrix 32 are either “0” or “1”. Further, the subsequences 36 are a part of the sequence 11 described above in connection with FIG. 3. Each subsequence 36 thus has a unique sequence value. The five subsequences in the columns in the second matrix 32 are then converted to five sequence values Sx₁, SX₂, SX₃, SX₄ and Sx₅, which define the x coordinate. Similarly, as shown in FIG. 6c, subsequences 37 with values 35 are arranged in rows in the third matrix 34. These subsequences are also parts of the sequence in FIG. 3 and are similarly converted to a second set Sy₁-Sy₅ of sequence values defining the y coordinate.

Subsequently, the difference between adjacent sequence values Sx and Sy is calculated, resulting in two sets of four difference values Dx₁-Dx₄ and Dy₁-Dy₄, respectively. These difference values Dx and Dy may then be used to generate an x and y coordinate. The equations below may be used to calculate the difference values:

Dxₙ=Sxₙ₊₁−Sxₙ modulo R,

and

Dyₙ=Syₙ₊₁−Syₙ modulo R,

where R is the number of unique subsequences in the sequence 11 of FIG. 3.

Systems consistent with the present invention may convert the difference values to coordinates in a number of ways. For example, the subsequences may be arranged such that one of the difference values in each matrix has an integer value in the range “0-3”. This codes the most significant digit. The subsequences may also be arranged so that the x coordinate will be one unit greater when moving one column to the right in the matrix. Similarly, the y coordinate will also be one unit greater when moving downward one row down in the matrix. Since, in this case, the columns in the second matrix in FIG. 6b consist of parts of the sequence 11 of FIG. 3, each of the sequence values in the two columns Sx₁ and Sx₂ furthest to the left in the matrix in FIG. 6b will be one unit greater when moving down one row in the matrix 32. However, Dx₁ remains constant. Consequently, the x coordinate also remains constant when moving downwards in the second matrix 32.

In systems consistent with the present invention, the image sensor 25 of vehicle 20 may record an image containing more position symbols than is needed to determine the position. According to one embodiment, the image sensor may record N×N position symbols (N>5), while only 5×5 position symbols may be needed to determine a position. This allows for error correction by using the other recorded position symbols in the position determination. For example, position symbols partly covered by dirt may not be recorded by the image sensor, and thus the other recorded position symbols may be used. In any event, any number of symbols may be used to code a position. The number of position coding symbols used in any specific embodiment will typically depend on how many position points need to be coded in the area.

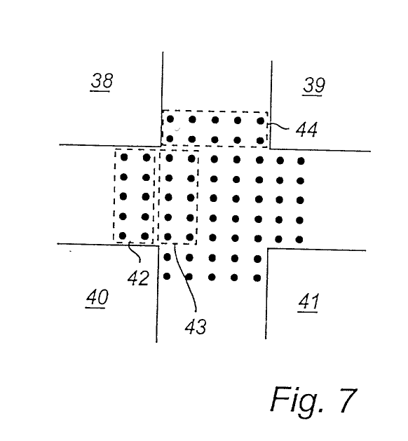

FIG. 7 illustrates an exemplary portion of the separating field 17 in FIG. 5. The separating field 17 preferably has a plurality of symbols, such as those described above with respect to FIG. 2, arranged in a manner similar to that of the position-coding pattern. FIG. 7 further shows four different floor plates 38 to 41, each having a different serial number defining its respective position in relation to the other plates on the floor. For example, plate 38 has the serial number “12” in the x-direction and the serial number “14” in the y-direction, plate 39 has the serial number “13” in the x-direction and the serial number “14” in the y-direction, plate 40 has the serial number “12” in the x-direction and the serial number “13” in the y-direction, and plate 41 has the serial number “13” in the x-direction and the serial number “13” in the y-direction.

The symbols within the frame 42 may be converted, in the manner described above, to a difference value for the x-coordinate. The x-coordinate value, which has the value “11” in this example, indicates the serial number of the adjacent floor plate in the x-direction (the plate to the left of the frame 42). Similarly, the symbols within the frame 43 correspond to a difference value in the x-direction having the value “12”. Further, the symbols within the frame 44 correspond to a difference value in the y-direction of “13”. Accordingly, by using the information contained in the separating fields, a vehicle can determine on which floor plate it is positioned.

It will be apparent to those skilled in the art that various modifications and variations can be made to the system and method of the present invention without departing from the spirit or scope of the invention. For example, while system has been described with respect to a vehicle operating in a storage area, the system may be used to control any vehicle operating on any type of surface having a position-coding pattern in a variety of applications. For instance, the vehicle may be used on an outside storage surface or even on a roof, and may increase the life of those surfaces by eliminating the need for persons to walk on it. The present invention covers the modifications and variations of this invention provided they come within the scope of the appended claims and their equivalents.

Concurrently filed with the application for this patent are applications entitled Systems and Methods for Information Storage based on Swedish Application No. 0000947-2, filed Mar. 21, 2000, and U.S. Provisional Application No. 60/207,839, filed May 30, 2000; Secured Access Using a Coordinate System based on Swedish Application No. 0000942-3, filed Mar. 21, 2000, and U.S. Provisional Application No. 60/207,850 filed on May 30, 2000; System and Method for Printing by Using a Position Coding Pattern based on Swedish Application No. 0001245-0, filed on Apr. 5, 2000, and U.S. Provisional Application No. 60/210,651, filed on Jun. 9, 2000; Apparatus and Methods Relating to Image Coding based on Swedish Application No. 0000950-6, filed on Mar. 21, 2000, and U.S. Provisional Application No. 60/207,838, filed on May 30, 2000; Apparatus and Methods for Determining Spatial Orientation based on Swedish Application No. 0000951-4, filed on Mar. 21, 2000, and U.S. Provisional Application No. 60/207,844, filed on May 30, 2000; System and Method for Determining Positional Information based on Swedish Application No. 0000949-8, filed Mar. 21, 2000, and U.S. Provisional Application No. 60/207,885, filed on May 30, 2000; Method and System for Transferring and Displaying Graphical Objects based on Swedish Application No. 0000941-5, filed Mar. 21, 2000, and U.S. Provisional Application No. 60/208,165, filed May 31, 2000; Online Graphical Message Service based on Swedish Application No. 0000944-9, filed Mar. 21, 2000, and U.S. Provisional Application No. 60/207,881, filed May 30, 2000; Method and System for Digitizing Freehand Graphics With User-Selected Properties based on Swedish Application No. 0000945-6, filed Mar. 21, 2000, U.S. Provisional Application No. 60/207,882, filed May 30, 2000; Data Form Having a Position-Coding Pattern Detectable by an Optical Sensor based on Swedish Application No. 0001236-9, filed Apr. 5, 2000, and U.S. Provisional Application No. 60/208,167, filed May 31, 2000; Method and Apparatus for Managing Valuable Documents based on Swedish Application No. 0001252-6, filed Apr. 5, 2000, and U.S. Provisional Application No. 60/210,653 filed Jun. 9, 2000; Method and Apparatus for Information Management based on Swedish Application No. 0001253-4 filed Apr. 5, 2000, and U.S. Provisional Application No. 60/210,652, filed Jun. 9, 2000; Device and Method for Communication based on Swedish Application No. 0000940-7, filed Mar. 21, 2000, and U.S. Provisional Application No. 60/208,166, filed May 31, 2000; Information-Related Devices and Methods based on Swedish Application No. 0001235-1, filed Apr. 5, 2000, and U.S. Provisional Application No. 60/210,647, filed Jun. 9, 2000; Processing of Documents based on Swedish Application No. 0000954-8, filed Mar. 21, 2000, and U.S. Provisional Application No. 60/207,849, filed May 30, 2000; Secure Signature Checking System based on Swedish Application No. 0000943-1, filed Mar. 21, 2000, and U.S. Provisional Application No. 60/207,880, filed May 30, 2000; Identification of Virtual Raster Pattern, based on Swedish Application No. 0001235-1, filed Apr. 5, 2000, and U.S. Provisional Application No. 60/210,647, filed Jun. 9, 2000, and Swedish Application No. 0004132-7, filed Nov. 10, 2000, and U.S. Provisional Application No. ______, filed Jan. 12, 2001; and a new U.S. Provisional Application entitled Communications Services Methods and Systems.

The technical disclosures of each of the above-listed U.S. applications, U.S. provisional applications, and Swedish applications are hereby incorporated herein by reference. As used herein, the incorporation of a “technical disclosure” excludes incorporation of information characterizing the related art, or characterizing advantages or objects of this invention over the related art.

In the foregoing Description of Preferred Embodiments, various features of the invention are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Preferred Embodiments, with each claim standing on its own as a separate preferred embodiment of the invention.

What is claimed is:

1. A surface for guiding a vehicle in an operating area, the surface comprising:
a position-coding pattern having an arbitrary subset of a predetermined size that identifies a unique position in the operating area, wherein the vehicle can determine its absolute position within the operating area by recording an image of the arbitrary subset on the surface.

2. The surface of claim 1, wherein the operating area comprises the entire surface such that each arbitrary subset identifies a unique position on the surface.

3. The surface of claim 1, wherein the operating area is formed of a plurality of similar partial operating areas, each having a corresponding position-coding pattern.

4. The surface of claim 1, wherein the operating area is formed of a plurality of partial operating areas separated by corresponding separating fields, each separating field containing a separating code identifying a corresponding partial area separated by the corresponding separating field.

5. The surface of claim 4, wherein the separating code includes a separating sequence such that a subsequence of a predetermined length defines a position of the subsequence in the separating sequence.

6. The surface of claim 1, wherein the position-coding pattern comprises a position sequence including a subsequence of a predetermined length that uniquely identifies a position of a subsequence in a position sequence.

7. The surface of claim 5, wherein the separating code is formed of separating symbols, wherein the position-coding pattern is formed of position symbols, and wherein the separating symbols are of a size different from a size of the position symbols.

8. The surface of claim 1, wherein the position-coding pattern further includes:
a matrix formed of a plurality of position symbols, wherein the matrix can be translated to a first value matrix with subsequences arranged in rows and to a second value matrix with subsequences arranged in columns, such that orthogonal coordinates are defined by at least one difference between sequence values in the first value matrix and at least one difference between sequence values in the second value matrix.

9. The surface of claim 8, wherein each position symbol contributes to position-coding in two orthogonal directions.

10. The surface of claim 8, wherein each position symbol consists of a marking of a particular size that defines a value of the symbol.

11. The surface of claim 8, wherein each position symbol consists of a marking such that the position of the marking in relation to a raster point defines a value of the symbol.

12. The surface of claim 1, wherein the position-coding pattern is optically recordable.

13. A self-guided vehicle for operation on a surface having a position-coding pattern thereon, the vehicle, comprising:
a control means for controlling movement of the vehicle; and
an image sensor for recording an image of the position-coding pattern on the surface,
wherein the control means converts the recorded position-coding pattern into a position of the vehicle, and wherein the control means controls the movement of the vehicle in response to the vehicle position relative to the position-coding pattern.

14. The vehicle of claim 13, further including a memory for storing the recorded image.

15. The vehicle of claim 14, wherein the memory stores information about the location of obstacles within a predetermined operation area, such that the control means controls the vehicle based in part on the location of the obstacles.

16. The vehicle of claim 15, wherein the memory stores information defining a pattern of movement of the vehicle.

17. The vehicle of claim 15, wherein the control means calculates a speed and a direction of the vehicle based on two recorded images and a time elapsed between the recording of the two images.

18. A method for guiding an automated self-propelled vehicle on a surface within an operating area, the method comprising:
storing information on the movement of the vehicle within the operating area;
recording an image of the surface, wherein the surface includes a position-coding pattern having an arbitrary subset of a predetermined size that defines a position in the operating area;
determining a position within the operating area based on the recorded image; and
controlling movement of the vehicle based on the determined position.

19. The method of claim 18, wherein a drawing of the operating area includes a position-coding pattern corresponding to the position-coding pattern included on the surface, the method further including:
determining a position path of the vehicle based on the position-coding pattern of the drawing;
controlling the movement of the vehicle in the operating area based on the determined position path.

20. The method of claim 18, wherein the vehicle determines the vehicle position.

21. The method of claim 18, wherein a computer external to the vehicle determines the vehicle position.

22. The method of claim 18, wherein the vehicle controls the movement of the vehicle.

23. The method of claim 18, wherein a computer external to the vehicle controls the movement of the vehicle.

24. The method of claim 18, wherein controlling the movement of the vehicle includes controlling the vehicle to move along a predetermined path.

25. The method of claim 18, wherein controlling the movement of the vehicle includes controlling the vehicle based on the positions of obstacles within the operation area.

26. A vehicle guiding system, comprising:
a surface having a position-coding pattern thereon, wherein the position-coding pattern has an arbitrary subset of a predetermined size that identifies a unique position in the operating area;
a control unit for receiving and transmitting position information;
an obstacle located in the operating area, wherein the obstacle transmits to the control unit position information defining the obstacle's position within the operating area; and
a vehicle equipped to record an image of the surface to determine a vehicle position within the operating area based on a recorded image of the position-coding pattern, and wherein the vehicle is equipped to receive information about the position of the obstacle from the control unit.

27. A system for controlling a vehicle, the system comprising:
a vehicle surface having a position-coding pattern thereon, wherein an arbitrary subset of a predetermined size in the position-coding pattern identifies a unique position on the vehicle surface; and
a vehicle movable on the vehicle surface, wherein the vehicle further includes:
an image sensor for recording an image of the arbitrary subset on the vehicle surface; and
control means for determining a position of the vehicle based on the recorded image and for controlling the movement of the vehicle based on the determined position.
